(19) United States
(12) Patent Application Publication
(10) Pub. No.: US 2024/0394105 A1
(43) Pub. Date: Nov. 28, 2024

(54) Anomaly-Aware Cloud Resource Management System Receiving External Information, and Including Short- and Long-Term Resource Planning

(71) Applicant: Telefonaktiebolaget LM Ericsson (publ), Stockholm (SE)

(72) Inventors: Marcial Gutierrez, Stockholm (SE); László Toka, Budapest (HU); Balázs Fodor, Isaszeg (HU); Balázs Sonkoly, Budapest (HU)

(21) Appl. No.: 18/697,563

(22) PCT Filed: Oct. 6, 2022
(86) PCT No.: PCT/IB2022/059567

§ 371 Date: Apr. 1, 2024

Related U.S. Application Data
(60) Provisional application No. 63/253,898, filed on Oct. 8, 2021.

(51) Int. Cl. G06F 9/50

(52) U.S. Cl. CPC G06F 9/5027

(57) ABSTRACT

An anomaly-aware resource management system (14) in a cloud computing system (10) monitors a telecommunication application executing in the cloud (10), and detects or predicts anomalies based on internal metrics related to the performance and/or resource usage of the application, and external metrics derived from information obtained from systems external to the cloud. The internal and external metrics are combined (210) to generate combined metrics, which are stored. Based on the combined metrics and historical data, anomalies are detected or predicted (212). Based in part on the detected or predicted anomaly, telecommunication traffic is forecast. Short-term resource calculations of application resource allocations are performed based on part of the forecast traffic and a short-term optimization policy. Long-term optimization of application resource allocations is performed based on the short-term calculations and a long-term optimization policy.

### RELATED APPLICATIONS

This application claims priority to U.S. Provisional patent Application Ser. No. 63/253,898 filed Oct. 8, 2021, the entire contents of which are incorporated herein by reference.

### FIELD OF INVENTION

The present invention relates generally to computer system management, and in particular to a system and method of anomaly-aware cloud resource management receiving external information, and including short- and long-term resource planning.

### BACKGROUND

The “cloud” is a generic term for computing systems in numerous private- and publicly-hosted data centers connected by various networks, including the Internet. Each data center provides a shared pool of computing resources, including e.g., servers and other computational hardware, data storage, network interfaces, operating systems, applications, services, and the like. Subscribers run applications remotely on the cloud servers and store data in the cloud data storage facilities. Subscribers typically access their data, and interface with the applications, via a network such as the Internet. Data center operators allocate computing resources, such as computational hardware, data storage, and the like, to each application.

The cloud provides numerous benefits to subscribers, including the ability to access their data, and run their applications, from any device with Internet connectivity. The data center operators perform routine technical tasks, such as replacing failed hardware, backing up data, upgrading software, providing rapid protection from evolving malware threats, and the like. The data centers have multiple redundant source of power, making them immune to local power outages. The data centers may be geographically distributed, making the cloud resilient to the effects of local weather or other natural disasters. The cloud alleviates subscribers from the expense and need for technical expertise to own and run their own Information Technology (IT) assets.

Subscribers' applications range from very small, such as an individual accessing an email server, to massive, such as implementing the functionality of some or all core network nodes of a regional or national telecommunications network. Data center operators allocate computing resources to applications according to their sizes and needs. Such allocation may be dynamic, with resources from a shared pool being allocated to an application in dependence on the ongoing needs of the application. Data center operators and subscribers negotiate a predetermined range of values for expected performance parameters (e.g., Key Performance Indicators, or KPIs) of an application, and agree to a predetermined range of expected resource use by the application to achieve the required performance. KPIs and other metadata may be logged, and the ranges of expected performance/resource parameters periodically adjusted to conform to actual use. The predetermined ranges of expected application performance and resource use may be quantified in Service Level Agreements (SLA).

Anomalies in application performance and/or resource use are known, and can arise from many different causes. For example, an increase in users accessing an application (load spike), component failures or network outages, malicious attacks, and the like, can all deleteriously affect performance of an application. As used herein, a computing system “anomaly” refers to the performance of an application falling outside its predetermined range of expected performance, and/or the application's need for computing resources goes outside the predetermined range of expected resource use by the application. In the face of such anomalies, data center operators may increase the computing resources allocated to an application-either manually or via automated Anomaly Detection and Resolution Systems (ADRS), in an attempt to maintain the performance within the SLA limits. For example, Kardani-Moghaddam, et al. describe such a system the paper, “ADRL: A Hybrid Anomaly-Aware Deep Reinforcement Learning-Based Resource Scaling in Clouds,” published in the journal IEEE Transactions on Parallel and Distributed Systems, vol. 32, no. 3, pp. 514-526, 1 Mar. 2021, the disclosure of which is incorporated herein by reference in its entirety.

Such anomaly-aware cloud resource management tools can detect abnormal patterns and take corrective actions to mitigate, or even prevent, the performance degradation of a cloud application. They monitor several metrics of the application and may calculate a probability, or a score, of having an anomaly. However, internal metrics of performance and resource use-meaning those captured from events or conditions within the computing system, such as CPU usage, memory use, data or message throughput, latency, Quality of Service (QOS), and the like-do not always exhibit a strong correlation with anomalies, particularly when the anomalies are triggered by external events or conditions. For example, in a telecommunications application, an event external to the cloud, such as a traffic incident, earthquake, or the like, will result in a large increase in traffic, as users place more calls. However, conventional anomaly-aware cloud resource management tools will only detect the anomaly when the effect reaches the application—that is, when the traffic load overwhelms some core network nodes. Hence, any remedial action, such as the allocation of additional resources to handle the increased call volume, is necessarily too late. The application performance will have already suffered, and some calls may be dropped, users cannot access the network, or other degradations to QoS will have occurred.

Another known area of cloud management is resource optimization. Resource optimization algorithms are widely employed to host and execute applications as cost-efficiently as possible. However, these techniques typically optimize only for the short term. Returning to the telecommunications application as an example, it may be assumed that user traffic is not accurately predictable very far in advance. If the cost of reallocation of resources to an application is not negligible, the short-term optimization may lead to suboptimal resource management in the long run.

The Background section of this document is provided to place embodiments of the present invention in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, an anomaly-aware resource management system in a cloud computing system monitors an application executing in the cloud, such as a telecommunication application, and detects or predicts anomalies based on internal metrics related to the performance and/or resource usage of the application, and external metrics derived from information obtained from systems external to the cloud. An external information extraction and analysis function generates the external metrics from the external information. A merging function combines the internal and external metrics to generate combined metrics, which are stored. Based on the combined metrics and historical data, anomalies are detected or predicted. An anomaly occurs when resource use by the application falls outside of the predetermined range of expected resource use, and/or performance of the application falls outside of the predetermined range of expected performance. Based in part on the detected or predicted anomaly, telecommunication traffic is forecast. Short-term resource calculations of application resource allocations are performed based on part of the forecast traffic and a short-term optimization policy. Long-term optimization of application resource allocations is performed based on the short-term calculations and a long-term optimization policy.

One embodiment relates to a method of managing computational resources within a computing system. An application is executed in the computing system, with a predetermined range of expected resource use by the application and a predetermined range of expected performance of the application. The application execution is monitored, and internal metrics related to resource use by, and performance of, the application are generated. Information relating to events external to the computing system is received. External metrics are extracted from the received information. External and internal metrics are merged to generate combined metrics. Based on the combined metrics, an anomaly is detected or predicted, wherein resource use by the application falls outside of the predetermined range of expected resource use, and/or performance of the application falls outside of the predetermined range of expected performance. Computing resources required by the application are determined based on the detected or predicted anomaly.

Another embodiment relates to an anomaly-aware resource management system executing in a computing system. The computing system executes a telecommunication application and receives information from an external system. The anomaly-aware resource management system includes a data store and computing resources. The computing resources are configured to implement: a system monitoring function configured to monitor the application and generate internal metrics related to the performance and/or resources usage of the application; an information extraction and analysis function configured to receive information from the external system and historical data from the date store, and further configured to generate external metrics; and a feature merging function configured to receive internal and external metrics, and further configured to generate combined metrics. The data store is configured to store the combined metrics. The anomaly-aware resource management system further includes an anomaly detection function configured to receive the combined metrics and historical data from the data store, and further configured to detect or predict an anomaly, wherein resource use by the application falls outside of a predetermined range of expected resource use, and/or performance of the application falls outside of a predetermined range of expected performance; and a traffic forecasting function configured to receive the combined metrics, historical data from the date store, the detected or predicted anomaly, and further configured to forecast telecommunication traffic. The anomaly-aware resource management system is configured to determine computing resources required by the application based on the traffic forecast and detected or predicted anomaly.

Yet another embodiment relates to a non-transitory computer readable medium containing instructions operative to cause computing resources in a computing system to implement an anomaly-aware resource management system. The anomaly-aware resource management system is configured to cause the computing resources to perform the following steps: executing an application in the computing system, with predetermined range of expected resource use by the application and predetermined range of expected performance of the application; monitoring the application execution, and generating internal metrics related to resource use by, and performance of, the application; receiving information relating to events external to the computing system; extracting external metrics from the received information; merging external and internal metrics to generate combined metrics; based on the combined metrics, detecting or predicting an anomaly, wherein resource use by the application falls outside of the predetermined range of expected resource use, and/or performance of the application falls outside of the predetermined range of expected performance; and determining computing resources required by the application based on the detected or predicted anomaly.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a block diagram of a computing system executing an application and an anomaly-aware resource management system.

FIG. 2 is a flow diagram of a method of resource management in a computing system.

FIG. 3 is a flow diagram of a method of managing computational resources within a computing system.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention. In order to describe aspects of embodiments of the present invention, the specific example of a telecommunications application, executing in a large computing system (also referred to as the cloud) is presented. Those of skill in the art will readily recognize that this example application is not a limitation of embodiments claimed herein, and that the inventive concepts described herein may readily and advantageously be applied to numerous different applications in a computing system.

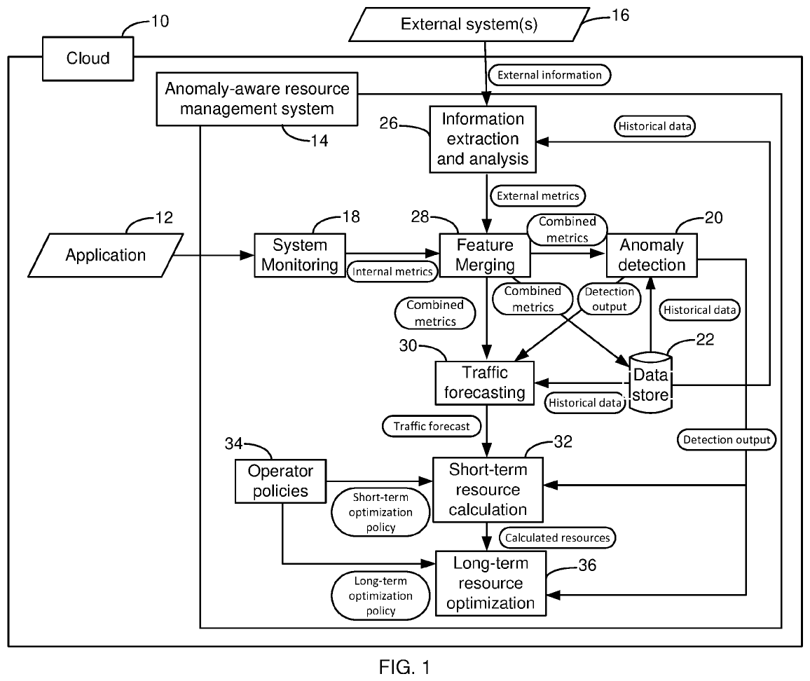

FIG. 1 depicts a computing system 10, also referred to as the cloud, a representative telecommunications application 12 executing in the computing system 10, and an anomaly-aware resource management system 14 monitoring the application 12 and also receiving information from external systems 16.

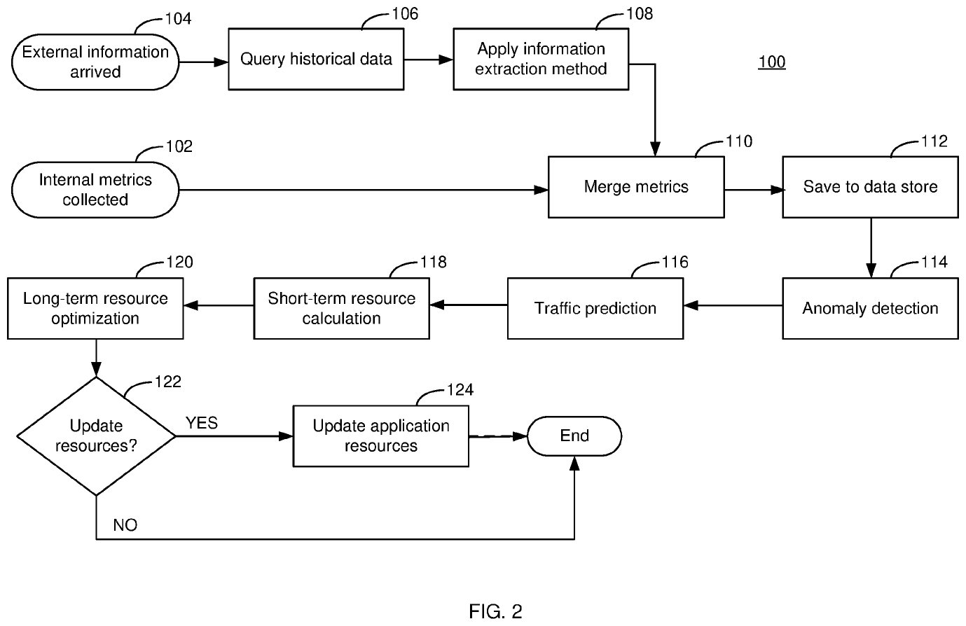

FIG. 2 depicts steps in a method 100 of managing resources in a computing system 10 executing an application 12.

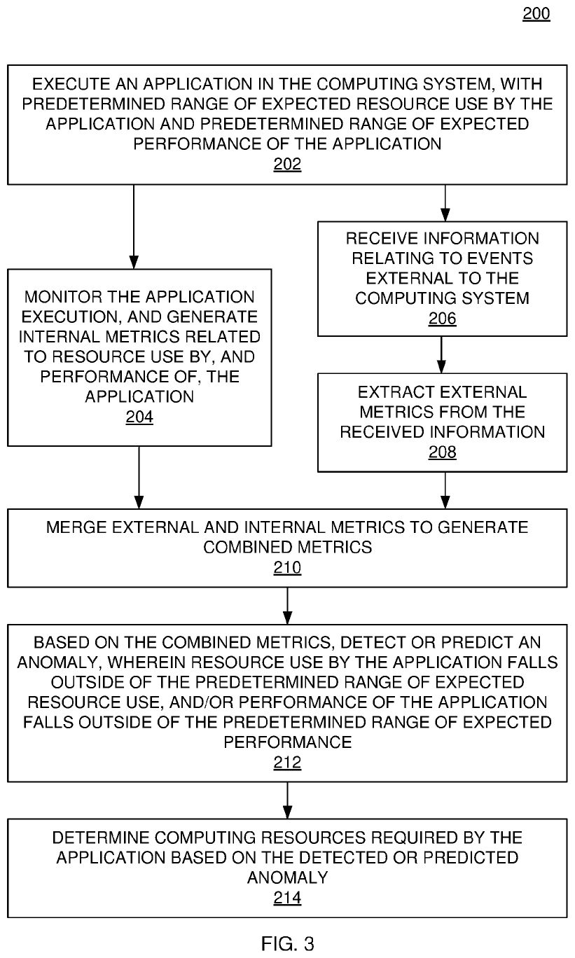

FIG. 3 depicts steps in a method 200 of managing computational resources within a computing system.

FIGS. 1, 2, and 3 are referenced concurrently in the following discussion.

As discussed above, some anomaly-aware resource management tools, operating to detect and correct anomalies in application 12 performance and/or resource utilization, are known. Some functions of such tools may include a system monitoring function 18 generating internal metrics; an anomaly detection function 20 detecting anomalies from the internal metrics and historical data stored in and retrieved from a data store 22, and, at least for the case of the telecommunications application 12, a traffic forecasting function 24. These functions 18, 20, 22, 24, in the context of a conventional resource management system, can detect anomalies in the performance and/or resource usage of the monitored application 12, based on internal metrics and historical data. Internal metrics are those detected within the computing system 10, and may include metrics such as CPU load, memory usage, number or timing of memory accesses, cache hit rates, number or rate of context switches, number or rate of interrupts processed, input/output volume and timing, power consumption, or other computational events or resource utilization within the computing system 10 that can be detected by the system monitoring function 18. The ongoing collection of internal metrics is depicted in FIG. 2 at step 102.

For many applications, such as the telecommunications application 12, more accurate predictions of traffic load are useful for predictive resource planning. Rather than only reacting to detected performance degradation due to increased traffic load, if the increased traffic load is predicted, resources can be added speculatively, avoiding an otherwise likely performance degradation. According to embodiments of the present invention, information is obtained from external systems 16 (step 104), and processed by an information extraction and analysis function 26 (step 108), along with historical data from the data store 22 (step 106), to generate external metrics useful for anomaly detection.

External systems 16 may comprise many types of information sources, which produce different types of information. For example, crowd-sourced navigation applications generate near-real-time road traffic congestion data, which may be supplemented by monitoring police, fire, and Emergency Medical Services (EMS) communications, video from traffic cameras, and the like. Traffic data can be useful in predicting telecommunications traffic, as drivers and passengers stuck in traffic may call others to adjust meeting times, may access traffic routing apps to find alternative routes, or otherwise access telecommunication networks. Similarly, weather forecasts can be monitored, as increased telecommunications traffic may be correlated with adverse or severe weather. Other examples include emergency broadcasts, which may warn of severe weather or other natural disasters (e.g., fire, earthquake, tsunami, or the like); the schedules of sports arenas, concert venues, and the like; financial markets data; news headlines; and the like.

Indeed, wireless telecommunications is so embedded a feature of modern life that network traffic is surprising correlated to a variety of seemingly unrelated factors. A recent paper by Rostami-Tabar, et al., “Forecasting COVID-19 daily cases using phone call data.” published in the journal Elsevier Applied Soft Computing, 2021, showed a correlation between daily calls to health care facilities and daily COVID-19 cases, and suggested that COVID-19 caseloads may be accurately predicted by monitoring the call traffic. The reverse of this correlation could be utilized to optimize the telecommunications application 12: as the daily count of COVID-19 cases increases, increased call traffic to health care facilities may be predicted, and appropriate resources assigned to the application 12. This correlation is an example of the diversity of sources and types of information, external to the cloud, that may be exploited to detect or predict anomalies in applications such as telecommunication applications.

Information from external systems 16 takes many forms, and requires processing to extract useful external metrics from it. An information extraction and analysis function 26 processes received external information (step 104), along with historical data from the data store 22 (step 106), to generate useful external metrics (step 108). The information extraction method applied depends on the type of the external data. For example, in case of text, advanced text processing techniques such as abstract generation, sentiment analysis, word2vec, and the like may be applied. For images and video, deep learning techniques such as Convolutional Neural Networks (CNN), transfer learning, large pretrained networks (e.g., InceptionV3), or other image processing methods may be suitable. Numerical data may be processed using statistical models, machine learning algorithms, or other numerical methods. In some cases, the external information may partially or fully pre-processed by an external system 16, simplifying the interpretation task of the information extraction and analysis function 26.

A feature merging function 28 merges internal metrics generated by the system monitoring function 18 and external metrics generated by the information extraction and analysis function 26, to generate combined metrics (step 110). The combined metrics are saved in the data store 22 (step 112), for use later during traffic prediction and further external information extraction. The combined metrics, along with historical data, are inputs to the anomaly detection function 20. The anomaly detection function 20 may operate similarly to known anomaly detection systems, which utilize only internal metrics, but with the further ability to utilize the external metrics components or aspects of the combined metrics. The anomaly detection function 20 detects whether the performance of application 12 or its resource utilization falls outside of the predetermined expected ranges—and also whether it is likely to do so in the near term, based on the combined metrics (step 114).

A traffic forecasting function 30 receives indications of anomalies from the anomaly detection function 20, as well as relevant combined metrics and historical data, and provides long-term forecasts about the dynamics of the future traffic load (step 116). The traffic forecasting function 30 may employ machine learning methods, such as recurrent neural networks (e.g., long short-term memory networks, or LSTM), or statistical methods (e.g., auto-regressive integrated moving average, or ARIMA), to generate the traffic prediction.

A short-term resource calculation function 32 receives the traffic forecast from the traffic forecasting function 30, anomaly detection output, and a short-term optimization policy from an operator policies function 34. The short-term resource calculation function 32 uses the predicted future traffic and performs a resource calculation for segments of the predicted traffic (step 118). For example, the short-term resource calculation function 32 may receive traffic prediction for the next two hours, and calculate resources for every 10 minutes.

The result of the short-term resource calculation is used by a long-term resource optimization function 36, along with anomaly detection output and a long-term optimization policy from the operator policies function 34, to calculate an optimal resource allocation for the entirety of the predicted traffic (step 120). The long-term resource optimization function 36 may change the calculated resources in order to meet the long-term optimization policy. If necessary (step 122), the resources assigned to the application 12 are then updated according to the results of the long-term optimization function 36 (step 124).

In one embodiment, the short-term and long-term resource calculation and optimization are performed as follows. Assume a traffic forecast is available for the next k time intervals (e.g., a one-day forecast in 5-minute intervals); that horizontal resource scaling is applied; that there is a near-linear relationship between the traffic value and the resource usage (i.e., 2,3 times larger traffic results in approximately 2,3 times more resource usage); and there exists a function ƒ that can calculate the expected resource usage from the traffic value.

The short-term resource calculation is based on a threshold. For every predicted traffic value vᵢ, the resource usage can be calculated using the assumed function ƒ as uᵢ=f(vᵢ). The operator can define a threshold value th (0<th<=1), which will be used as the over-provisioning/cost optimization target. th=x means that the operator wishes to set the resources in such a way that only (x×100)% resources should be used—the other part should be reserved. For example, th=0.5 would be set for a 50% over-provision. With the threshold value, the short-term resource usage can be calculated for every uᵢ resource usage value according to:

$${s}_{i} = ⌈ \frac{{u}_{i}}{th} ⌉$$

where sᵢ denotes the optimal number of instances for every i interval.

The long-term resource optimization function 36 receives the sᵢ values from the short-term resource calculation function 32. These define the short-term optimized resource usage, which is considered a suggestion, or starting point. The long-term resource optimization function 36 outputs decisions dᵢ, which are the final optimized resource allocations for every i interval. The following cost function is used for long-term resource optimization:

$$C = 12 \times {c}_{r} \times {\sum }_{i = 1}^{k} {( {d}_{i} - {s}_{i} )}^{2} + \frac{1}{2} \times ( 1 - {c}_{r} ) \times {\sum }_{i = 2}^{k} {( {d}_{i} - {d}_{i - 1} )}^{2}$$

where cᵣ is the cost ratio, which describes the weight of two cost components (described below), and dᵢ is the final resource decision in the i^{th} time interval. During optimization, these are the variables for which the optimal values will be determined. Si is the suggested resource usage for the i^{th} interval (from the short-term resource calculation), and k is the number of time intervals.

The cost function consists of two components. The first part is called idle cost, which defines the cost of running additional resources above the short-term optimized value. This also means that the following constraint stands for every i:

$${s}_{i} \leq {d}_{i}$$

The second part of the cost function is called adaptation cost, which reflects the cost of changing the resources allocated to the application 12 between intervals i. The adaptation cost is here defined as the square of the resource change between subsequent time intervals. For example, if 5 CPU cores are allocated in dᵢ₋₁ and 3 CPU cores are allocated in dᵢ, then the resource change is −2 CPU cores—the adaptation cost is the square of that, so 4 is taken into the sum for this particular time interval pair. Note that, because of the square function, the adaptation cost is the same whether additional resources are allocated to the application 12, or whether excess resources are removed from the application 12.

The long-term optimization process consists of two steps. First, the optimal solution is determined without the constraints. Second, the intervals are checked whether corrective action is needed or not.

To obtain optimal decisions, the gradient of the cost function VC is calculated, where the vector operator V contains the partial differentials with respect to the decisions:

$$∇ = ( \begin{matrix}\frac{\partial }{\partial {d}_{1}} \\ \frac{\partial }{\partial {d}_{2}} \\ ⋮ \\ \frac{\partial }{\partial {d}_{k}}\end{matrix} )$$

The gradient of the cost function has the following form:

$$∇ C = ( \begin{matrix}\frac{\partial C}{\partial {d}_{1}} \\ \frac{\partial C}{\partial {d}_{2}} \\ ⋮ \\ \frac{\partial C}{\partial {d}_{k}}\end{matrix} ) = ( \begin{matrix}{c}_{r} ( {d}_{1} - {s}_{1} ) - ( 1 - {c}_{r} ) ( {d}_{2} - {d}_{1} ) \\ {c}_{r} ( {d}_{2} - {s}_{2} ) + ( 1 - {c}_{r} ) ( {d}_{2} - {d}_{1} ) - ( 1 - {c}_{r} ) ( {d}_{3} - {d}_{2} ) \\ ⋮ \\ {c}_{k} ( {d}_{k} - {s}_{k} ) + ( 1 - {c}_{r} ) ( {d}_{k} - {d}_{k - 1} )\end{matrix} )$$

The goal is to minimize the cost function. If the gradient of the cost function is zero, there can be an extremum at certain d₁, d₂, . . . , dₖ values. The expression ∇C=0 can be written as a matrix equation Ad⁰=b, where all the variables dᵢ can be separated and collected into a vector d⁰. The structures of the matrices are as follows:

$$A = ( \begin{matrix}1 & {c}_{r} - 1 & 0 & 0 & ⋯ & 0 \\ {c}_{r} - 1 & 2 - {c}_{r} & {c}_{r} - 1 & 0 & ⋯ & 0 \\ 0 & {c}_{r} - 1 & 2 - {c}_{r} & {c}_{r} - 1 & ⋯ & 0 \\ & & ⋱ & ⋱ & ⋱ & \\ 0 & ⋯ & 0 & {c}_{r} - 1 & 2 - {c}_{r} & {c}_{r} - 1 \\ 0 & ⋯ & 0 & 0 & {c}_{r} - 1 & 1\end{matrix} ) \\ b = ( \begin{matrix}{c}_{r} {s}_{1} \\ {c}_{r} {s}_{2} \\ ⋮ \\ {c}_{r} {s}_{k} - 1 \\ {c}_{r} {s}_{k}\end{matrix} ) {d}^{0} = ( \begin{matrix}{d}_{1} \\ {d}_{2} \\ ⋮ \\ {d}_{k - 1} \\ {d}_{k}\end{matrix} )$$

The matrix A is invertable, therefore there exists a solution for the vector d⁰, which is the optimal solution without constraints.

Having obtained d⁰, constraints are now introduced. If the initial decision d⁰ in the i^{th} interval is larger than the suggested value sᵢ, then there are no conditions for the interval. However, if the decision dᵢ⁰ is smaller than the suggested value, the condition is imposed that the decision should be equal to the suggestion.

The vector g∈R^{M} is the constraint vector, where M≤k.

The indices of the intervals are collected, where the conditions are defined into a vector denoted by m=[m₁, m₂, . . . , m_{M}]. For example, if d₂<s₂ and d₃<s₃ are true, then m=[2,3] and

$$g ( d ) = \{ {d}_{i} - {s}_{i} , if {d}_{i}^{0} < {s}_{i} \} , i = 1 , 2 , … , k \\ g ( d ) = ( \begin{matrix}{d}_{2} - {s}_{2} \\ {d}_{3} - {s}_{3}\end{matrix} )$$

With this approach, inequalities are avoided, and the conditions are reduced to simple equations. The method of Lagrange multipliers is applied to solve this conditional extremum problem. The state space is extended with the vector of Lagrange multipliers λ∈R^{M}, which has the same dimensions as the constraint vector g. The new cost function is:

$${C}^{1} ( d , λ ) = C ( d ) + {λ}^{T} g ( d )$$

The same approach described earlier is applied. The gradient of C¹ is calculated; the gradient should be equal to zero at the optimal solution; and the matrix equation is built based on the gradient. Note that with the introduction of the Lagrange multipliers, the state of the unknowns is extended. The differential operator is changed:

$${∇}^{1} = ( \begin{matrix}\frac{\partial }{\partial {d}_{1}} \\ \frac{\partial }{\partial {d}_{2}} \\ ⋮ \\ \frac{\partial }{\partial {d}_{k}} \\ \frac{\partial }{\partial {λ}_{{m}_{1}}} \\ ⋮ \\ \frac{\partial }{\partial {λ}_{{m}_{M}}}\end{matrix} )$$

The gradient of the new cost function is:

$${∇}^{1} {C}^{1} = ( \begin{matrix}\frac{\partial {C}^{1} ( d , λ )}{\partial d} \\ g ( d )\end{matrix} )$$

After collecting the terms from |¹C¹=0 the matrix equation has the form:

$$( \begin{matrix}A & δ \\ {δ}^{T} & {0}_{M \times M}\end{matrix} ) ( \begin{matrix}d \\ λ\end{matrix} ) = ( \begin{matrix}b \\ {b}_{g}\end{matrix} )$$

The matrices A and b were defined previously. Vector b contains the unknown decisions for the given intervals, and A contains the unknown Lagrange multipliers. To consider the constraints, b_{g}∈R^{M} and σ∈R^{k×M} are introduced.

$${b}_{g} = ( \begin{matrix}{s}_{{m}_{1}} \\ ⋮ \\ {s}_{{m}_{M}}\end{matrix} ) \\ {σ}_{ij} = \{ \begin{matrix}1 & if i = {m}_{j} \\ 0 & if i \neq {m}_{j}\end{matrix} , i = 1 , 2 , … , k and j = 1 , 2 , … , M$$

where mⱼ are the elements of the m vector denoting the intervals for which the conditions are defined. After solving the final matrix equation for the decision vector d the optimal solution is obtained, which is allowed by the constraints.

If horizontal scaling is assumed, then the final elements of the decision vector d should be rounded up, to obtain the correct resource values.

In the paper “LSSO: Long Short-term Scaling Optimizer,” Balàzs Fodor, Làszlò Toka, and Balàzs Sonkoly of the MTA-BME Network Softwarization Research Group, Budapest University of Technology and Economics, present a long-term resource scaling optimization applicable to telecommunications applications in a cloud environment. The long short-term scaling optimization problem (LSSOP) considers long-term predictions on instance numbers and takes a predefined cost model into account for the overall optimization. An optimizer method solving the LSSOP is based on a transformation to a shortest path problem, and provides an optimal solution in polynomial time. The authors consider the impact of inaccurate predictions by using two forecast methods. One uses the previous day's traffic for the current day; the other uses the same with added noise, which makes the prediction accuracy weaker. The maximum cost gain can never be reached while the scaling cost is low. Also, the cost gain can be negative compared to the short-term optimal allocation, because the short-term resource suggestion is preferred when the scaling cost is small, and the optimization using inaccurate values might execute unnecessary scaling actions which will increase the cost. As the scaling cost gets higher, the effect of inaccurate predictions becomes less and less noticeable, as the optimized allocation uses more instances than suggested to prevent scaling actions, and a small inaccuracy in instance number will not take effect. As a result, the cost gain fairly approximates the cost gain of the perfect prediction. Hence, with the increase of scaling cost, the prediction accuracy becomes less prominent, and near maximal cost gain can be achieved.

FIG. 3 depicts the steps in a method 200 of managing computational resources within a computing system. An application is executed in the computing system, with predetermined range of expected resource use by the application and predetermined range of expected performance of the application (block 202). The application execution is monitored, and internal metrics related to resource use by, and performance of, the application are generated (block 204). In parallel, information relating to events external to the computing system is received (block 206), and external metrics are extracted from the received information (block 208). The external and internal metrics are merged to generate combined metrics (block 210). Based on the combined metrics, an anomaly is detected or predicted, wherein resource use by the application falls outside of the predetermined range of expected resource use, and/or performance of the application falls outside of the predetermined range of expected performance (block 212). Computing resources required by the application are determined based on the detected or predicted anomaly (block 214).

Embodiments of the present invention present numerous advantages over the prior art. Anomaly detection/prediction is more accurate, for those cases where external events impact application performance. By generating external metrics, events that impact application performance are detected sooner, and degradation of application performance can be proactively avoided. By performing both short-term calculations, and long-term optimization, of application resource allocation, the resource allocation is more robust and cost-efficient.

In accordance with various embodiments of the present invention, the methods described herein are intended for operation as software programs running on a computer processor or other appropriate computing resources. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a non-transitory, computer-readable, tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to E-mail or other self-contained information archive or set of archives is considered a distribution medium equivalent to a non-transitory, computer-readable, tangible storage medium. Accordingly, embodiments of the invention described herein are considered to include a non-transitory, computer-readable, tangible storage medium or distribution medium, as listed herein and including art-recognized equivalents and successor media, in which the software implementations herein are stored.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description. As used herein, the term “configured to” means set up, organized, adapted, or arranged to operate in a particular way; the term is synonymous with “designed to.” As used herein, the term “substantially” means nearly or essentially, but not necessarily completely; the term encompasses and accounts for mechanical or component value tolerances, measurement error, random variation, and similar sources of imprecision.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-22. (canceled)

23. A method of managing computational resources within a computing system, comprising:
executing an application in the computing system, with predetermined range of expected resource use by the application and predetermined range of expected performance of the application;
monitoring the application execution, and generating internal metrics related to resource use by, and performance of, the application;
receiving information relating to events external to the computing system;
extracting external metrics from the received information;
merging external and internal metrics to generate combined metrics;
based on the combined metrics, detecting or predicting an anomaly, wherein resource use by the application falls outside of the predetermined range of expected resource use, and/or performance of the application falls outside of the predetermined range of expected performance; and
determining computing resources required by the application based on the detected or predicted anomaly.

224. The method of claim 23 further comprising saving the combined metrics, and wherein detecting or predicting an anomaly is further based on historical values of combined metrics.

25. The method of claim 24 wherein the application is a telecommunication application, and further comprising:
forecasting traffic based on the detected or predicted anomaly and current and/or historical values of combined metrics; and
wherein determining computing resources required by the application is further based on traffic forecasts.

26. The method of claim 25 wherein determining computational resources required by the application based on the detected or predicted anomaly comprises:
calculating short-term resources required by the application; and
optimizing long-term resources required by the application based on the short-term resource calculation.

27. The method of claim 26 wherein calculating short-term resources required by the application comprises calculating the short-term resources required based on forecast traffic, a short-term optimization policy provided by an operator of the computing system, and the detected or predicted anomaly.

28. The method of claim 26 wherein optimizing long-term resources required by the application is further based on a long-term optimization policy provided by an operator of the computing system, and the detected or predicted anomaly.

29. The method of claim 28 further comprising allocating the optimized long-term resources to the application.

30. The method of claim 28 wherein calculating short-term resources required by the application comprises, for each of a plurality of time intervals i:
calculating a resource usage uᵢ for the interval i based on a forecast traffic value vᵢ for the interval using a function ƒ where uᵢ=f(vᵢ);
defining a threshold value th in the range 0<th<=1 as an over-provisioning target; and
calculating a short-term number sᵢ of instances for a resource for the interval i by
$${s}_{i} = ⌈ \frac{{u}_{i}}{th} ⌉ .$$

31. The method of claim 30 wherein optimizing long-term resources required by the application based on the short-term resource calculation comprises, for each time interval i for which a short-term resource allocation sᵢ was calculated, determining a decision dᵢ representing a final optimized allocation of a resource for the interval i based on a cost function comprising an idle cost representing the cost of allocating additional resources above the short-term optimized value, and an adaptation cost reflecting the cost of changing the resource allocation between intervals i.

32. The method of claim 31 wherein the cost function is
$$C = \frac{1}{2} \times {c}_{r} \times {\sum }_{i = 1}^{k} {( {d}_{i} - {s}_{i} )}^{2} + \frac{1}{2} \times ( 1 - {c}_{r} ) \times {\sum }_{i = 2}^{k} {( {d}_{i} - {d}_{i - 1} )}^{2}$$
where cᵣ is the cost ratio, which describes the weight of idle cost and adaptation cost;
dᵢ is the final resource decision in the i^{th} time interval;
sᵢ is the calculated short-term resource allocation for the i^{th} interval; and
k is the number of time intervals.

33. The method of claim 32 wherein, for every interval i, sᵢ≤dᵢ.

34. The method of claim 33, further comprising calculating an optimal solution to the cost function without constraints by:
calculating a gradient of the cost function ∇C where
$$∇ = ( \begin{matrix}\frac{\partial }{\partial {d}_{1}} \\ \frac{\partial }{\partial {d}_{2}} \\ ⋮ \\ \frac{\partial }{\partial {d}_{k}}\end{matrix} ) ;$$
and
solving ∇C=0 to obtain a vector d⁰ of optimized resource allocation decisions without constraints, where
$${d}^{0} = ( \begin{matrix}{d}_{1} \\ {d}_{2} \\ ⋮ \\ {d}_{k - 1} \\ {d}_{k}\end{matrix} ) .$$

35. The method of claim 34, further comprising applying the constraint that, for each interval i, if the unconstrained optimal allocation dᵢ⁰<sᵢ, then dᵢ⁰=sᵢ.

36. An anomaly-aware resource management system executing in a computing system, the computing system executing a telecommunication application and receiving information from an external system, the anomaly-aware resource management system comprising:
a data store; and
computing resources configured to implement:
a system monitoring function configured to monitor the application and generate internal metrics related to the performance and/or resources usage of the application;
an information extraction and analysis function configured to receive information from the external system and historical data from the date store, and further configured to generate external metrics;
a feature merging function configured to receive internal and external metrics, and further configured to generate combined metrics;
wherein the data store is configured to store the combined metrics;
an anomaly detection function configured to receive the combined metrics and historical data from the data store, and further configured to detect or predict an anomaly, wherein resource use by the application falls outside of a predetermined range of expected resource use, and/or performance of the application falls outside of a predetermined range of expected performance;
a traffic forecasting function configured to receive the combined metrics, historical data from the date store, the detected or predicted anomaly, and further configured to forecast telecommunication traffic;
wherein the anomaly-aware resource management system is configured to determine computing resources required by the application based on the traffic forecast and detected or predicted anomaly.

37. The system of claim 36, wherein the computing resources are further configured to implement:
a short-term resource calculation function configured to receive traffic forecasts, historical data from the data store, and a short-term optimization policy from an operator of the computing system, and further configured to calculate short-term resource allocations for the application; and
a long-term resource optimization function configured to receive the calculated short-term resource allocations, historical data from the data store, and a long-term optimization policy from the computing system operator, and further configured to optimize long-term resource allocations for the application.

38. The system of claim 37 wherein the short-term resource calculation function is configured to calculate short-term resources allocations for the application by, for each of a plurality of time intervals i:
calculating a resource usage uᵢ for the interval i based on a forecast traffic value vᵢ for the interval using a function ƒ where uᵢ=f(vᵢ);
defining a threshold value th in the range 0<th<=1 as an over-provisioning target; and
calculating a short-term number sᵢ of instances for a resource for the interval i by
$${s}_{i} = ⌈ \frac{{u}_{i}}{th} ⌉ .$$

39. The system of claim 37 wherein the long-term resource optimization function is configured to optimize long-term resource allocations for the application by, for each time interval i for which a short-term resource allocation sᵢ was calculated, determining a decision dᵢ representing a final optimized allocation of a resource for the interval i based on a cost function comprising an idle cost representing the cost of allocating additional resources above the short-term optimized value, and an adaptation cost reflecting the cost of changing the resource allocation between intervals i.

40. The system of claim 39 wherein the cost function is
$$C = \frac{1}{2} \times {c}_{r} \times {\sum }_{i = 1}^{k} {( {d}_{i} - {s}_{i} )}^{2} + \frac{1}{2} \times ( 1 - {c}_{r} ) \times {\sum }_{i = 2}^{k} {( {d}_{i} - {d}_{i - 1} )}^{2}$$
where cᵣ is the cost ratio, which describes the weight of idle cost and adaptation cost;
dᵢ is the final resource decision in the i^{th} time interval;
sᵢ is the calculated short-term resource allocation for the i^{th} interval; and
k is the number of time intervals.

41. The system of claim 40 wherein, for every interval i, sᵢ≤dᵢ.

42. The system of claim 41, wherein the long-term resource optimization function is further configured to calculate an optimal solution to the cost function without constraints by:
calculating a gradient of the cost function ∇C where
$$∇ = ( \begin{matrix}\frac{\partial }{\partial {d}_{1}} \\ \frac{\partial }{\partial {d}_{2}} \\ ⋮ \\ \frac{\partial }{\partial {d}_{k}}\end{matrix} ) ;$$
and
solving ∇C=0 to obtain a vector d⁰ of optimized resource allocation decisions without
constraints, where
$${d}^{0} = ( \begin{matrix}{d}_{1} \\ {d}_{2} \\ ⋮ \\ {d}_{k - 1} \\ {d}_{k}\end{matrix} ) .$$

43. The system of claim 42, wherein the long-term resource optimization function is further configured to apply the constraint that, for each interval i, if the unconstrained optimal allocation dᵢ⁰<sᵢ, then dᵢ⁰=sᵢ.

44. A non-transitory computer readable medium containing instructions operative to cause computing resources in a computing system to implement an anomaly-aware resource management system configured to cause the computing resources to perform the following steps:
executing an application in the computing system, with predetermined range of expected resource use by the application and predetermined range of expected performance of the application;
monitoring the application execution, and generating internal metrics related to resource use by, and performance of, the application;
receiving information relating to events external to the computing system;
extracting external metrics from the received information;
merging external and internal metrics to generate combined metrics;
based on the combined metrics, detecting or predicting an anomaly, wherein resource use by the application falls outside of the predetermined range of expected resource use, and/or performance of the application falls outside of the predetermined range of expected performance; and
determining computing resources required by the application based on the detected or predicted anomaly.
